(19) United States
(12) Patent Application Publication
(10) Pub. No.: US 2006/0217952 A1
(43) Pub. Date: Sep. 28, 2006

(54) Backup/recovery system and methods regarding the same

(75) Inventors: Sword Wu, Chongqing (CN); Tree Yan, Chongqing (CN)

Correspondence Address: ARENT FOX PLLC, 1050 CONNECTICUT AVENUE, N.W., SUITE 400, WASHINGTON, DC, 20036, US

(73) Assignee: Far Stone Tech. Inc.

(21) Appl. No.: 11/332,473

(22) Filed: Jan. 17, 2006

(30) Foreign Application Priority Data
Jan. 14, 2005 (TW) 94101056

(51) Int. Cl. G06F 9/455

(52) U.S. Cl. 703/24

(57) ABSTRACT

A backup/recovery system and methodology that conveniently backs up/restores data in a computer system. According to the invention, backup/recovery method is suitable for a computer system including at least one hard disk (HD). The computer system is coupled to at least one data storage device. The backup method comprises the steps of: generating a first emulator of the hard disk; generating a second emulator of the data storage device; and writing data in the first emulator to the second emulator, wherein the data is being cloned from the hard disk to the data storage device, so as to achieve backup/recovery operation between two hard disks, and enhance the efficiency.

### CROSS-REFERENCE TO RELATED APPLICATIONS

The present application claims priority, under 35 U.S.C. § 119, to foreign application no. 94101056 filed Jan. 14, 2005 in Taiwan, the contents thereof incorporated by reference herein by its entirety.

### BACKGROUND OF THE INVENTION

1. Field of the Invention

The present invention relates generally to a backup/recovery technique for a computer system, and more particularly to a backup/recovery system and method that unifies procedure of backup and simplifies procedure of recovery.

2. Description of Prior Art

Conventional backup/recovery technique creates a number of image files to backup data by using backup/recovery software. When the computer system goes “belly up”, the image file is used to restore the computer system to a previous state.

The conventional backup/recovery technique uses the type of data flow to execute the backup/recovery operation. The backup/recovery operation may be a hard disk to hard disk operation, a partition to partition operation, a partition to image file operation and an image file to partition operation.

The procedure of creating the image file is complicated. It depends on several situations and may be classified into a file level image file and a sector level image file. The file level image file backs up files in selected partitions of a hard disk to the image file. And the sector level image file backs up sectors in selected partitions to the image file.

The image file can be file level or sector level. However the hard disk includes a plurality of partitions, the procedure of backing up the hard disk is not unified. Moreover, the procedure of recovering the image file is complicated as well. When executing the recovery operation, the conventional backup/recovery software recovers data in accordance with the previous created image file.

Generally, the backed up image file can only be used in the conventional backup/recovery technique. For example, the conventional backup/recovery software, such as the Ghost software developed by Symantec Corporation, includes a program to access data stored in the image file. As such, current techniques available in the conventional backup/recovery software provide no notion of how to make good use of image file.

### SUMMARY OF THE INVENTION

The present invention provides a backup/recovery system and method to resolve the foregoing problems faced by the conventional backup/recovery software. The present invention also has the advantage of providing a new practical application to the image file.

An object of the present invention is to provide a backup/recovery system and method, wherein a HD/partition can be emulated in a RAM. Data in the emulated HD/partition can be copied into other emulated HD/partition, which will be emulated into an image file.

Another object of the present invention is to provide a backup/recovery system and method, which can achieve the backup/recovery operation between two hard disks, regardless of what kind the image files are being created, regardless of the amount of the partitions involved.

A further object of the present invention is to provide a backup/recovery system and method, which can implement the image file by conventional Virtual PC software, to enhance the usage of the image file.

In accordance with an aspect of the present invention, a backup method is suitable for a computer system. The computer system includes at least one hard disk. The computer system is coupled to at least one data storage device. The backup method comprises the steps of: generating a first emulator of the hard disk; generating a second emulator of the data storage device; and writing data in the first emulator to the second emulator, wherein the data is being cloned from the hard disk to the data storage device.

In the preferred embodiment of the invention, the first emulator is located in a memory of the hard disk. The data storage device is a hard disk or a partition. The second emulator is located in a memory of the data storage device. The backup method further comprises the step of emulating the second emulator into an image file. The hard disk has at least one partition. The at least one of the partition is being emulated into the first emulator. The data storage device may be an external storage media. The writing step comprises the substep of locating data to the first emulator. The writing step comprises the substep of locating data to the image file. The first emulator and the second emulator are suitable for a Virtual PC software respectively.

In accordance with another aspect of the present invention, a recovery method is suitable for a computer system. The computer system includes at least one hard disk. The computer system is coupled to at least one data storage device. The data storage device has an image file, the recovery method comprises the steps of: selecting, in the image file, data that is to be restored the at least one hard disk; generating a first emulator of the hard disk; generating a second emulator of the image file; and writing data in the second emulator to the first emulator.

In the preferred embodiment of the invention, the hard disk has at least one partition.

In accordance with a further aspect of the present invention, an implementing method for a Virtual PC software is suitable for a computer system. The computer system includes at least one image file and a Virtual PC software. The image file has a backed up data. The implementing method comprises the steps of: emulating the image file into a virtual hard disk; and implementing the virtual hard disk by the Virtual PC software thereby without having an operating system.

In the preferred embodiment of the invention, the implementing method further comprises the step of determining the backed up data. The backed up data keeps data of a hard disk/partition. The virtual hard disk includes the partition. The implementing step comprises the substep of locating data.

The present invention may best be understood through the following description with reference to the accompanying drawings, in which:

### BRIEF DESCRIPTION OF THE DRAWINGS

FIG. 1 shows a schematic diagram of a backup/recovery system of a preferred embodiment according to the present invention, wherein the backup operation is executed.

FIG. 2 shows a schematic diagram of a backup/recovery system of a preferred embodiment according to the present invention, wherein the recovery operation is executed.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes a new backup technique for a backup/recovery system to create a HD level image file to backup data, which can unify procedure of backup and simplify procedure of recovery. Moreover, the confusion and difficulty of distinguishing the image file is eliminated. Accordingly, the problem of complicated implementation can be solved completely, the efficiency of the described backup/recovery system can be increased. The presently described backup/recovery system, thus, serves users' demands much more adequately.

According to the preferred embodiment of the present invention, a backup method is suitable for a computer system. The computer system includes at least one hard disk. The computer system is coupled to at least one data storage device. The backup method comprises the steps of: generating a first emulator of the hard disk; generating a second emulator of the data storage device; and writing data in the first emulator to the second emulator, wherein the data is being cloned from the hard disk to the data storage device.

The first emulator is located in a memory of the hard disk. The data storage device is a hard disk or a partition. The second emulator is located in a memory of the data storage device. The backup method further comprises the step of emulating the second emulator into an image file. The at least one of the partition is being emulated into the first emulator. The data storage device may be an external storage media. The writing step comprises the substep of locating data to the first emulator. The writing step comprises the substep of locating data to the image file. The first emulator and the second emulator are suitable for a Virtual PC software respectively.

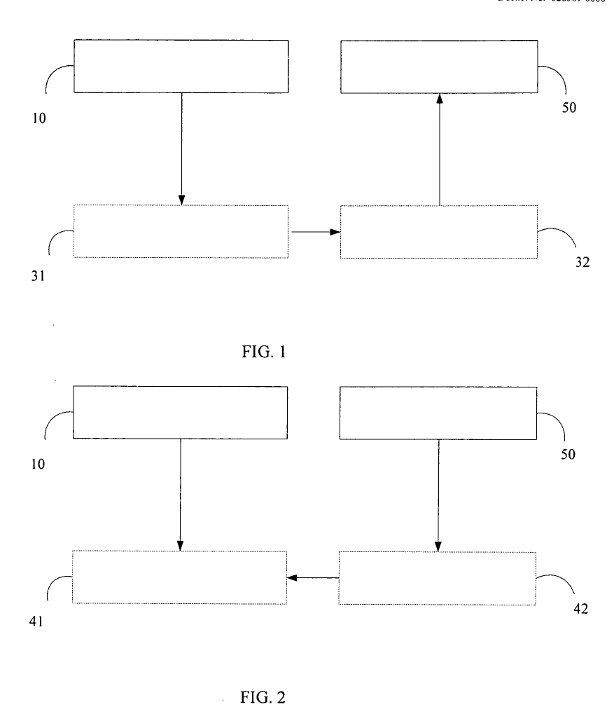

Referring to FIG. 1, a schematic diagram of a backup system of a preferred embodiment according to the present invention is shown. The backup system of the present invention is suitable for a computer system, which includes at least one HD/partition 10. The computer system is coupled to at least one data storage device (not shown).

The data storage device is used to keep backed up data of the HD/partition 10. The data storage device may be an internal/external storage media. The data storage device can be a hard disk or a partition. Otherwise the data storage device can be a memory. The backup system includes at least an emulating module.

The users can select to back up data containing in the HD/partition 10. The emulating module is used to generate a first emulator 31 of the HD/partition 10 and generate a second emulator 32 of the data storage device.

The first emulator 31 and the second emulator 32 is a kind of virtual hard disk, which is located in a RAM of a hard disk. Architecture of physical hard disk, the first emulator 31 and the second emulator 32 is identical. Data in the first emulator 31 is written to the second emulator 32. Hence, the data can be cloned from the hard disk to the data storage device. And the second emulator 32 can be further emulated into an image file 50 for later recovery operation.

In case of the users select to back up data containing in at least one partition, which is included in a hard disk 10, the first emulator 31 just consists of a partition index head and corresponding partition. The data containing in the partition of the hard disk 10 is located to the corresponding partitions of the first emulator 31.

Besides, in case of the users select to back up data in the entire HD, the HD locates every data to first emulator 31. Then the data located to the corresponding partitions of the first emulator 31 is written to the second emulator 32. Meanwhile the data containing in the partition of the second emulator 32 is located to the image file 50.

According to the preferred embodiment of the present invention, an implementing method for a Virtual PC software is suitable for a computer system. The computer system includes at least one image file and a Virtual PC software. The image file has a backed up data. The implementing method comprises the steps of: emulating the image file into a virtual hard disk; and implementing the virtual hard disk by the Virtual PC software thereby without having an operating system.

The implementing method further comprises the step of determining the backed up data. The backed up data keeps data of a hard disk/partition. The virtual hard disk includes the partition. The implementing step comprises the substep of locating data.

The image file 50, the first emulator 31 and the second emulator 32 (as shown in FIG. 1) are suitable for a Virtual PC software respectively. The image file 50 can be emulated into a virtual hard disk. The implementing method for the conventional Virtual PC software is suitable for a computer system. The computer system includes at least one image file 50 and the conventional Virtual PC software, such as the VMWare software developed by VMWare Corporation. The image file has a backed up data. The backed up data keeps data of a hard disk/partition.

First, determine whether the backed up data is a backup of an entire HD or at least one partition. Then emulate the image file into a virtual hard disk. The virtual hard disk is implemented by the Virtual PC software. Since the image file 50 can be emulated from a HD emulator, the virtual hard disk emulated from such image file 50 can act as a hard disk with an operating system. The operation can be executed without having an operating system thereby.

According to the preferred embodiment of the present invention, a recovery method is suitable for a computer system. The computer system includes at least one hard disk. The computer system is coupled to at least one data storage device. The data storage device has an image file, the recovery method comprises the steps of: selecting, in the image file, data that is to be restored the at least one hard disk; generating a first emulator of the hard disk; generating a second emulator of the image file; and writing data in the second emulator to the first emulator. The hard disk has at least one partition.

Referring to FIG. 2, a schematic diagram of a recovery system of a preferred embodiment according to the present invention is shown. The recovery system of the present invention is suitable for a computer system, which includes at least one HD/partition 10. The computer system implements at least one image file 50.

The image file 50 keeps previous backed up data of the HD/partition 10. The image file 50 is stored in a data storage device. The data storage device may be an internal/external storage media. The data storage device can be a hard disk or a partition. The backup/recovery system includes at least an emulating module.

The emulating module is used to generate a first emulator 41 of the HD/partition 10 and generate a second emulator 42 of the selected data. The users can select backed up data containing in the image file 50 to recover the HD/partition 10.

The first emulator 41 and the second emulator 42 is a kind of virtual hard disk, which is located in a RAM of a hard disk. Architecture of physical hard disk, the first emulator 41 and the second emulator 42 is identical. Data in the second emulator 42 is written to the first emulator 41. Hence, the data can be cloned from the data storage device to the hard disk.

In case of the users select to recover data of at least one partition, which is included in the hard disk 10, the second emulator 42 consists of the at least one partition. The backed up data of the partition of the hard disk 10 is located to the corresponding partitions of the second emulator 42.

Besides, in case of the users select backed up data of the entire HD, the image file 50 locates every data to second emulator 42. Then the data located to the corresponding partitions of the second emulator 42 is written to the first emulator 41 Meanwhile the data containing in the partition of the first emulator 41 is located to the HD/partition 10.

The backup/recovery method according to the present invention can unify and simplify procedure of backup/recovery. Moreover, the implementing method can provide a new practical application of the Virtual PC software.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A backup method, suitable for a computer system including at least one hard disk, said computer system being coupled to at least one data storage device, said backup method comprising the steps of:
generating a first emulator of said hard disk;
generating a second emulator of said data storage device; and
writing data in said first emulator to said second emulator.

2. The backup method according to claim 1, wherein said first emulator is located in a memory of said hard disk.

3. The backup method according to claim 1, wherein said data storage device is a hard disk.

4. The backup method according to claim 1, wherein said second emulator is located in a memory of said data storage device.

5. The backup method according to claim 1, further comprising the step of emulating said second emulator into an image file.

6. The backup method according to claim 1, wherein said hard disk has at least one partition.

7. The backup method according to claim 6, wherein at least one of said partition is being emulated into said first emulator.

8. The backup method according to claim 1, wherein said data storage device is a partition.

9. The backup method according to claim 1, wherein said data storage device is a memory.

10. The backup method according to claim 1, wherein said writing step comprises the substep of locating data to said first emulator.

11. The backup method according to claim 5, wherein said writing step comprises the substep of locating data to said image file.

12. The backup method according to claim 1, wherein said first emulator and said second emulator are suitable for a Virtual PC software respectively.

13. A recovery method, suitable for a computer system including at least one hard disk, said computer system implementing at least one image file, said recovery method comprising the steps of:
selecting, in said image file, data that is to be restored said at least one hard disk;
generating a first emulator of said hard disk;
generating a second emulator of said selected data; and
writing data in said second emulator to said first emulator.

14. The recovery method according to claim 13, wherein said hard disk has at least one partition.

15. An implementing method for a Virtual PC software, suitable for a computer system including at least one image file and a Virtual PC software, said image file having a backed up data, said implementing method comprising the steps of:
emulating said image file into a virtual hard disk; and
implementing said virtual hard disk by said Virtual PC software thereby without having an operating system.

16. The implementing method according to claim 15, further comprising the step of determining said backed up data.

17. The implementing method according to claim 16, wherein said backed up data keeps data of a hard disk.

18. The implementing method according to claim 16, wherein said backed up data keeps data of a partition.

19. The implementing method according to claim 18, wherein said virtual hard disk includes said partition.

20. The implementing method according to claim 15, wherein said implementing step comprises the substep of locating data.
